(19) United States
(12) Patent Application Publication
(10) Pub. No.: US 2020/0312471 A1
(43) Pub. Date: Oct. 1, 2020

(54) Corrosion Mitigation Method for Carbon Steel Pipe

(71) Applicant: Hitachi-GE Nuclear Energy, Ltd., Hitachi-shi (JP)

(72) Inventors: Kazushige ISHIDA, Tokyo (JP); Masahiko TACHIBANA, Tokyo (JP); Mayu SASAKI, Hitachi-shi (JP); Ryosuke SHIMIZU, Hitachi-shi (JP)

(21) Appl. No.: 16/807,917

(22) Filed: Mar. 3, 2020

(30) Foreign Application Priority Data
Mar. 28, 2019 (JP) 2019-063088

(51) Int. Cl. G21C 17/022; G21C 1/08; G21C 19/307; C23F 14/02; C22C 38/18; C22C 38/04; C22C 38/02; C22C 38/00

(52) U.S. Cl. CPC G21C 17/0225; G21C 1/084; G21C 19/307; C22C 38/002; C22C 38/18; C22C 38/04; C22C 38/02; C23F 14/02

(57) ABSTRACT

To provide a corrosion mitigation method for carbon steel pipe that can further reduce corrosion of the carbon steel pipe. In a BWR plant, oxygen is injected from an oxygen injection device 30 into a clean up system pipe 18 which is constituted by a Cr-containing carbon steel pipe containing Cr in a range of larger than 0.052 wt % and less than 0.4 wt % and being in communication with a RPV 3, and reactor water of 150° C. having a dissolved oxygen concentration of 30 μg/L is generated. The reactor water is brought into contact with an inner surface of the clean up system pipe 18 to perform an oxidizing treatment on the inner surface, and an oxide film containing Cr is formed on the inner surface. Thus, after the oxide film is formed, hydrogen is injected into the reactor water in the RPV 3 through a water supply pipe 11 in communication with to the RPV 3, and even when the dissolved oxygen concentration in the reactor water in contact with the inner surface of the clean up system pipe 18 is reduced to 2 μg/L, corrosion of the clean up system pipe 18 is remarkably mitigated.

### CLAIM OF PRIORITY

The present application claims priority from Japanese Patent application serial No. 2019-063088, filed on Mar. 28, 2019, the content of which is hereby incorporated by reference into this application.

### BACKGROUND OF THE INVENTION

### 1. Field of the Invention

The present invention relates to a corrosion mitigation method for carbon steel pipe, and more particularly, to a corrosion mitigation method for a carbon steel pipe suitable for application to a boiling water reactor plant.

### 2. Description of the Related Art

In a reactor plant, it is important to mitigate corrosion of a carbon steel pipe from a viewpoint of improving an operation rate of the reactor plant and reducing an exposure. It is known that a thickness of a carbon steel pipe in which high-temperature water with a low dissolved oxygen concentration of about several μg/L flows at a flow rate of several m/s in a temperature range of 100° C. to 200° C. decreases due to the corrosion.

In a boiling water reactor plant (hereinafter referred to as a BWR plant), steam generated in a reactor pressure vessel (referred to as RPV) is guided to a turbine to rotate the turbine. The steam discharged from the turbine is condensed into water by a condenser. The water is supplied to the RPV as supplied water through a water supply pipe of a water supply system.

In order to mitigate generation of radioactive corrosion products in the RPV, a metal impurity contained in the supplied water is removed with a demineralizer provided in the water supply pipe. Further, a radionuclide contained in cooling water (hereinafter referred to as reactor water) in the RPV is removed by a reactor water clean up device provided in a clean up system pipe in communication with the RPV of a reactor water clean up system.

In the BWR plant, a carbon steel pipe is used for the water supply pipe, the clean up system pipe, and a residual heat removal system pipe of a residual heat removal system in communication with the RPV. In the water supply pipe, the corrosion of the water supply pipe is mitigated by injecting oxygen into an upstream portion of the water supply pipe such that an oxygen concentration of the supplied water is several tens of μg/L. In the BWR plant where hydrogen is not injected to lower the dissolved oxygen concentration in the reactor water by injecting the hydrogen from the water supply pipe, since oxygen generated by radiolysis of the reactor water in the RPV is dissolved in the reactor water, the corrosion of the carbon steel pipe (for example, the clean up system pipe) in communication with the RPV is mitigated.

JP-A-9-5489 discloses that corrosion of a residual heat removal system pipe is mitigated by preliminarily passing high-temperature water at 100° C. to 240° C. that does not contain radioactive materials through the residual heat removal system pipe, which is the carbon steel pipe, and performing an oxidizing treatment on an inner surface of the residual heat removal system pipe.

In the BWR plant, in order to mitigate an occurrence of stress corrosion cracking in a stainless steel structure in the RPV and a stainless steel pipe that is in communication with the RPV, through which the reactor water flows, and propagation of the stress corrosion cracking, a hydrogen water chemistry for lowering the dissolved oxygen concentration contained in the reactor water by injecting the hydrogen from the water supply pipe is applied. Further, in the BWR plant, a noble metal such as platinum is injected into the reactor water. With a catalysis of the platinum, the injected hydrogen reacts with the dissolved oxygen in the reactor water to produce water. Thus, there is a problem that the dissolved oxygen concentration of the reactor water falls to about several μg/L, and the carbon steel pipe, such as the cleanup system pipe of the reactor water cleanup system, through which the reactor water having a lowered dissolved oxygen concentration flows is corroded.

A pressurized water reactor plant (hereinafter referred to as PWR plant) includes a primary system through which the reactor water heated by heat generated by nuclear fission of nuclear materials contained in a fuel assembly loaded in a reactor core of the reactor pressure vessel flows, and a secondary system that introduces steam generated from water heated by the heat of the reactor water in a steam generator to the turbine. The secondary system includes a water supply pipe which is the carbon steel pipe and supplies water generated by condensing the steam discharged from the turbine by the condenser to the steam generator.

With removal of dissolved gas with a deaerator and addition of chemicals such as hydrazine for reacting with oxygen to lower the oxygen concentration for improving soundness of materials used in the steam generator, the dissolved oxygen contained in the supplied water guided by the water supply pipe is lowered to several μg/L or less. For corrosion mitigation of the water supply pipe, in a case where alkaline chemicals such as ammonia are added to make a pH of the supplied water alkaline, a corrosion rate of the water supply pipe is higher than a case where oxygen is injected at several tens of μg/L to increase the dissolved oxygen concentration.

When the corrosion of the carbon steel pipe progresses and the thickness of the carbon steel pipe becomes a predetermined value or less, it is necessary to stop and replace the reactor plant, so that an operating rate of the reactor plant decreases. The radioactive materials adhere to an inner surface of the clean up system pipe of the BWR plant. Since the pipe and the structure to which the radioactive materials adhere are nearby, there is a possibility that an operator is exposed along with the replacement of the carbon steel pipe. Therefore, it is important to mitigate the corrosion of the carbon steel pipe from a viewpoint of improving the operation rate of the reactor plant and reducing an exposure.

### SUMMARY OF THE INVENTION

An object of the invention is to provide a corrosion mitigation method for carbon steel pipe that can further reduce corrosion of the carbon steel pipe.

A feature of the invention that achieves the above object of the invention is supplying oxygen-containing water to a Cr-containing carbon steel pipe containing in a range of larger than 0.052 wt % and less than 0.4 wt %, which constitutes a carbon steel pipe of a reactor plant, and performing an oxidizing treatment on an inner surface of the Cr-containing carbon steel pipe with the oxygen-containing water.

In order to perform the oxidizing treatment on the inner surface of the Cr-containing carbon steel pipe with the oxygen-containing water in the Cr-containing carbon steel pipe containing Cr in the range of larger than 0.052 wt % and less than 0.4 wt %, which constitutes the carbon steel pipe of the reactor plant, an oxide film containing Cr is formed on the inner surface of the Cr-containing carbon steel pipe, and after the oxidizing treatment is completed, the oxide film remains on the inner surface even when water having an oxygen concentration (for example, an oxygen concentration of 2 μg/L or less) lower than the oxygen concentration (for example, an oxygen concentration in a range of 10 μg/L or more and 300 μg/L or less) of the oxygen-containing water when forming the oxide film comes into contact with the oxide film formed on the inner surface of the Cr-containing carbon steel pipe. Thus, corrosion of the Cr-containing carbon steel pipe is mitigated remarkably.

According to the invention, the corrosion of the carbon steel pipe of the reactor plant can be further reduced.

### BRIEF DESCRIPTION OF THE DRAWINGS

FIG. 1 is an explanatory diagram of a corrosion mitigation method for carbon steel pipe according to a first embodiment applied to a boiling water reactor plant, which is a preferred embodiment of the invention.

FIG. 2 is an explanatory diagram showing corrosion amounts in a corrosion test of a carbon steel containing 0.015 wt % Cr and a carbon steel containing 0.31 wt % Cr.

FIG. 3 is an explanatory diagram showing corrosion amounts in a corrosion test of a carbon steel containing 0.052 wt % Cr and a carbon steel containing 0.13 wt % Cr.

FIG. 4 is an explanatory diagram showing corrosion rates of the carbon steels in respective corrosion tests.

FIG. 5 is a characteristic diagram showing a relationship between a Cr content and the corrosion rate.

FIG. 6 is an explanatory diagram of a corrosion mitigation method for carbon steel pipe according to a second embodiment, which is another preferred embodiment of the invention.

FIG. 7 is an explanatory diagram of a corrosion mitigation method for carbon steel pipe according to a third embodiment applied to the boiling water reactor plant, which is another preferred embodiment of the invention.

FIG. 8 is an explanatory diagram of a corrosion mitigation method for carbon steel pipe according to a fourth embodiment applied to a pressurized water reactor plant, which is another preferred embodiment of the invention.

### DESCRIPTION OF THE PREFERRED EMBODIMENTS

Inventors have conducted various studies on measures for mitigating corrosion of a carbon steel pipe. As a result, the inventors have found an effective method capable of mitigating the corrosion of the carbon steel pipe. The result of the studies will be described below.

The inventors performed a corrosion experiment of a Cr-containing carbon steel pipe, in order to investigate the corrosion of a pipe made from a Cr-containing carbon steel (hereinafter referred to as the Cr-containing carbon steel pipe). In this corrosion experiment, as test pieces, four types of carbon steel pipes including a carbon steel pipe containing 0.015 wt % of Cr (referred to as a Cr 0.015 wt %-containing carbon steel pipe), a carbon steel pipe containing 0.052 wt % of Cr (referred to as a Cr 0.052 wt %-containing carbon steel pipe), a carbon steel pipe containing 0.13 wt % of Cr (referred to as a Cr 0.13 wt %-containing carbon steel pipe), and a carbon steel pipe containing 0.31 wt % of Cr (referred to as a Cr 0.31 wt %-containing carbon steel pipe) were used.

Each of the Cr 0.015 wt %-containing carbon steel pipe (No. 1), the Cr 0.052 wt %-containing carbon steel pipe (No. 2), the Cr 0.13 wt %-containing carbon steel pipe (No. 3), and the Cr 0.31 wt %-containing carbon steel pipe (No. 4), as shown in Table 1, contains each element of C, Si, Mn, P, C, Cr and Fe, and a content of each element contained in each Cr-containing carbon steel pipe is expressed in wt % in Table 1. No. 1 to No. 4 in parentheses correspond to those shown in Table 1.

TABLE 1
Unit: wt %

| No. | C | Si | Mn | P | S | Cr | Fe |
|---|---|---|---|---|---|---|---|
| 1 | 0.31 | 0.19 | 0.50 | 0.012 | 0.002 | 0.015 | Remainder |
| 2 | 0.31 | 0.20 | 0.50 | 0.012 | 0.002 | 0.052 | Remainder |
| 3 | 0.30 | 0.20 | 0.50 | 0.013 | 0.002 | 0.13 | Remainder |
| 4 | 0.30 | 0.21 | 0.50 | 0.013 | 0.002 | 0.31 | Remainder |

First, the corrosion experiment was performed using the Cr 0.015 wt %-containing carbon steel pipe. In the corrosion experiment, high-temperature water at 190° C. was supplied to the Cr 0.015 wt %-containing carbon steel pipe at a flow rate of 2 m/s. The high-temperature water passed through the carbon steel pipe. As the high-temperature water, high-temperature water adjusted to a low dissolved oxygen concentration (for example, 2 μg/L) and high-temperature water adjusted to a dissolved oxygen concentration necessary for an oxidizing treatment (for example, 30 μg/L) were used. High-temperature water having a dissolved oxygen concentration of 2 μg/L and a temperature in a range of 100° C. to 200° C., for example, 190° C., and high-temperature water of 190° C. having a dissolved oxygen concentration of 30 μg/L were alternately supplied to the Cr 0.015 wt %-containing carbon steel pipe.

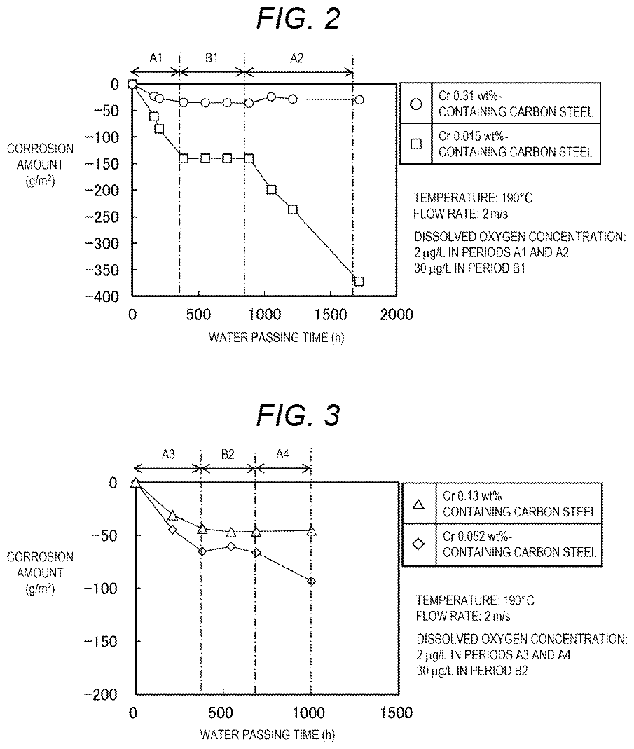

Specifically, the high-temperature water of 190° C. having the dissolved oxygen concentration of 2 μg/L was supplied to the Cr 0.015 wt %-containing carbon steel pipe in a period A1 (see FIG. 2) from 0 to 390 hours. The “0 hour” is a time when the supply of the high-temperature water of 190° C. having the dissolved oxygen concentration of 2 μg/L to the Cr 0.015 wt %-containing carbon steel pipe is started. The “390 hours” and each time described later (for example, 890 hours and 1700 hours) are elapsed times based on a starting point of the supply of the high-temperature water to the Cr 0.015 wt %-containing carbon steel pipe.

When 390 hours was reached, instead of the high-temperature water of 190° C. having the dissolved oxygen concentration of 2 μg/L, the high-temperature water of 190° C. having the dissolved oxygen concentration of 30 μg/L was supplied to the Cr 0.015 wt %-containing carbon steel pipe, and the high-temperature water passed through the Cr 0.015 wt %-containing carbon steel pipe. The high-temperature water of 190° C. having the dissolved oxygen concentration of 30 μg/L was supplied to the Cr 0.015 wt %-containing carbon steel pipe in a period B1 (see FIG. 2) from 390 hours to 890 hours. Further, when 890 hours was reached, instead of the high-temperature water of 190° C. having the dissolved oxygen concentration of 30 μg/L, again the high-temperature water of 190° C. having the dissolved oxygen concentration of 2 μg/L was supplied to the Cr 0.015 wt %-containing carbon steel pipe, and the high-temperature water passed through the Cr 0.015 wt %-containing carbon steel pipe. The high-temperature water of 190° C. having the dissolved oxygen concentration of 2 μg/L was supplied to the Cr 0.015 wt %-containing carbon steel pipe in a period A2 (see FIG. 2) from 890 hours to 1720 hours.

In the period B1 during which the high-temperature water of 190° C. having the dissolved oxygen concentration of 30 μg/L passed through the Cr 0.015 wt %-containing carbon steel pipe, by bringing the high-temperature water containing 30 μg/L dissolved oxygen into contact with an inner surface of the Cr 0.015 wt %-containing carbon steel pipe, the inner surface was subjected to the oxidizing treatment. In the period B1 during which the inner surface was subjected to the oxidizing treatment, since an oxide film containing Cr was formed on the inner surface by the oxidizing treatment, as clear from FIG. 2, the corrosion did not occur in the Cr 0.015 wt %-containing carbon steel pipe. However, before the period B1, in the period A1 during which the high-temperature water of 190° C. having the dissolved oxygen concentration of 2 μg/L was in contact with the inner surface of the Cr 0.015 wt %-containing carbon steel pipe, the corrosion occurred, and a weight of the Cr 0.015 wt %-containing carbon steel pipe was reduced by 150 g/m². In the period A2 after the period B1, the inner surface of the Cr 0.015 wt %-containing carbon steel pipe again was brought into contact with the high-temperature water of 190° C. having 2 μg/L dissolved oxygen. In the period A2, the corrosion of the Cr 0.015 wt %-containing carbon steel pipe progressed, and the weight of the Cr 0.015 wt %-containing carbon steel pipe decreased in the same gradient as in the period A1.

Next, a similar experiment was performed on the Cr 0.31 wt %-containing carbon steel pipe. In the periods A1 and A2, the high-temperature water of 190° C. having 2 μg/L dissolved oxygen was supplied to the Cr 0.31 wt %-containing carbon steel pipe, in the period B1, the high-temperature water of 190° C. having 30 μg/L dissolved oxygen was supplied to the Cr 0.31 wt %-containing carbon steel pipe, and then the oxidizing treatment was performed on the inner surface of the Cr 0.31 wt %-containing carbon steel pipe. In the period A1, the corrosion occurred in the Cr 0.31 wt %-containing carbon steel pipe, and the weight of the Cr 0.31 wt %-containing carbon steel pipe decreased, but the reduction amount was about 40 g/m² and was remarkably less than the amount of the Cr 0.015 wt %-containing carbon steel pipe. The oxide film containing Cr was formed on the inner surface of the Cr 0.31 wt %-containing carbon steel pipe by the oxidizing treatment on the inner surface. In the period B1 during which the oxidizing treatment was performed on the inner surface, a degree of the corrosion of the Cr 0.31 wt %-containing carbon steel pipe was constant without change. In the period A2, unlike the Cr 0.015 wt %-containing carbon steel pipe where the corrosion progressed remarkably, the corrosion of the Cr 0.31 wt %-containing carbon steel pipe did not progress and was almost constant.

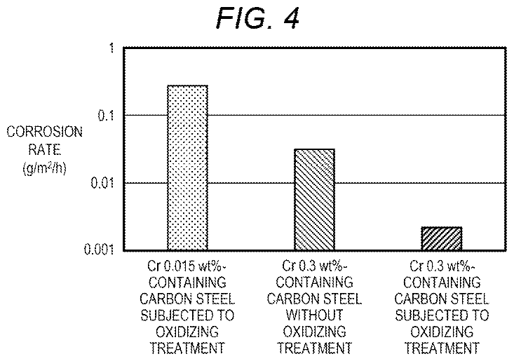

Further, the same experiment was also performed on the Cr 0.052 wt %-containing carbon steel pipe and the Cr 0.13 wt %-containing carbon steel pipe. However, to the Cr 0.052 wt %-containing carbon steel pipe and the Cr 0.13 wt %-containing carbon steel pipe, the high-temperature water of 190° C. having 2 μg/L dissolved oxygen was supplied at 2 m/s in periods A3 and A4, and the high-temperature water of 190° C. having 30 μg/L dissolved oxygen was supplied at 2 m/s in a period B2, as shown in FIG. 3. There was the period B2 (from 380 hours to 690 hours) after the period A3 (from 0 hours to 380 hours), and there was the period A4 (from 690 hours to 1000 hours) after the period B2. Each of the Cr 0.052 wt %-containing carbon steel pipe and the Cr 0.13 wt %-containing carbon steel pipe corroded in the period A3, and the corrosion amount of the Cr 0.13 wt %-containing carbon steel pipe at the end of the period A3 was less than that of the Cr 0.052 wt %-containing carbon steel pipe. The corrosion amount of the Cr 0.052 wt %-containing carbon steel pipe was substantially constant during the period B2, but increased during the period A4. On the other hand, the corrosion amount of the Cr 0.13 wt %-containing carbon steel pipe was substantially constant during the periods B2 and A4.

When the amount of Cr contained in the Cr-containing carbon steel pipe was small, the oxide film formed on the inner surface of the Cr-containing carbon steel pipe was mainly Fe₃O₄. When the dissolved oxygen concentration of the high-temperature water in contact with the inner surface of the Cr-containing carbon steel pipe was low (for example, 2 μg/L), Fe₃O₄ formed on the inner surface was reduced and dissolved. As a result, the corrosion of the Cr 0.015 wt %-containing carbon steel pipe progressed in the period A2 (see FIG. 2). Further, the corrosion amount of the Cr 0.052 wt %-containing carbon steel pipe in the period A4 was increased due to the a reductive dissolution of Fe₃O₄ formed on the inner surface of the pipe. However, since the Cr 0.052 wt %-containing carbon steel pipe had a Cr content higher than that of the Cr 0.015 wt %-containing carbon steel pipe, the corrosion amount of the Cr 0.052 wt %-containing carbon steel pipe in the period A4 was smaller than the corrosion amount of the Cr 0.015 wt %-containing carbon steel pipe in the period A2.

In each of the Cr 0.13 wt %-containing carbon steel pipe and the Cr 0.31 wt %-containing carbon steel pipe, even when the high-temperature water of 190° C. having a low dissolved oxygen concentration, for example, 2 μg/L, was brought into contact with a surface of the oxide film containing Cr formed on the inner surface of each Cr-containing carbon steel pipe, as shown in FIGS. 2 and 3, the corrosion amount of the Cr 0.31 wt %-containing carbon steel pipe in the period A2 and the corrosion amount of the Cr 0.13 wt %-containing carbon steel pipe in the period A4 did not increase as the Cr 0.052 wt %-containing carbon steel pipe and the Cr 0.015 wt %-containing carbon steel pipe. This was because during the periods B1 and B2, the inner surfaces of the Cr 0.13 wt %-containing carbon steel pipe and the Cr 0.31 wt %-containing carbon steel pipe were formed with Fe₃₋ₓCrₓO₄ (0<x≤1) oxide films containing a small amount of Cr. Fe₃₋ₓCrₓO₄ (0<x≤1.0), as the oxide film containing a small amount of Cr, was difficult to be reductively dissolved even when the high-temperature water of 190° C. having a low dissolved oxygen concentration, for example, 2 μg/L, was brought into contact the surface of Fe₃₋ₓCrₓO₄ (0<x≤1), as the oxide film containing a small amount of Cr.

According to the experiment results shown in FIGS. 2 and 3, in the Cr 0.13 wt %-containing carbon steel pipe and the Cr 0.31 wt %-containing carbon steel pipe, the corrosion amount does not decrease even after the period of the oxidizing treatment (periods B1 and B2) elapsed. As a result, it has been found that the carbon steel pipe having a Cr content larger than 0.052 wt % is prevented from being corroded and the corrosion amount is remarkably reduced. The inventors have recognized that in order to mitigate the corrosion of the Cr-containing carbon steel pipe, the Cr content of the Cr-containing carbon steel pipe may just be made larger than 0.052 wt %. Moreover, the Cr content of the Cr-containing carbon steel pipe is preferably less than 0.4 wt %. It has been recognized that the Cr content of the Cr-containing carbon steel pipe is preferably larger than 0.052 wt %. When the Cr content of the Cr-containing carbon steel pipe is 0.4 wt % or more, in a case where the Cr-containing carbon steel pipe is welded to another member such as another Cr-containing carbon steel pipe, there is a possibility that Cr segregation occurs in a welded portion thereof. Thus, it is necessary to make the Cr content of the Cr-containing carbon steel pipe less than 0.4 wt %. Therefore, the Cr content of the Cr-containing carbon steel pipe may be set to a ratio in a range of larger than 0.052 wt % and less than 0.4 wt %.

Preferably, the Cr content of the Cr-containing carbon steel pipe is in a range of 0.13 wt % or more and less than 0.4 wt %.

The Cr-containing carbon steel pipe containing the Cr in the range of larger than 0.052 wt % and less than 0.4 wt % is a Cr-containing carbon steel pipe containing Cr in the range of larger than 0.052 wt % and less than 0.4 wt %, C in a range of 0.30 wt % to 0.33 wt % (0.30 wt % or more and 0.33 wt % or less), Si in a range of 0.10 wt % to 0.35 wt % (0.10 wt % or more and 0.35 wt % or less), Mn in a range of 0.30 wt % to 1.00 wt % (0.30 wt % or more and 1.00 wt % or less), P in an amount of 0.035 wt % or less, S in an amount of 0.035 wt % or less, and Fe as a remainder. In this Cr-containing carbon steel pipe, “Cr in the range of larger than 0.052 wt % and less than 0.4 wt %” may be changed to “Cr in the range of 0.06 wt % or more and 0.39 wt % or less”.

Preferably, the Cr-containing carbon steel pipe containing the Cr in a range of 0.13 wt % or more and less than 0.4 wt % is a Cr-containing carbon steel pipe containing Cr in the range of 0.13 wt % or more and less than 0.4 wt %, C in a range of 0.30 wt % to 0.33 wt % (0.30 wt % or more and 0.33 wt % or less), Si in a range of 0.10 wt % to 0.35 wt % (0.10 wt % or more and 0.35 wt % or less), Mn in a range of 0.30 wt % to 1.00 wt % (0.30 wt % or more and 1.00 wt % or less), P in an amount of 0.035 wt % or less, S in an amount of 0.035 wt % or less, and Fe as a remainder. In this Cr-containing carbon steel pipe, “Cr in the range of 0.13 wt % or more and less than 0.4 wt %” may be changed to “Cr in the range of 0.13 wt % or more and 0.39 wt % or less”.

When performing the oxidizing treatment on the inner surface of the Cr-containing carbon steel pipe containing the Cr in the range of larger than 0.052 wt % and less than 0.4 wt %, water containing oxygen having a concentration in a range of 10 μg/L or more and 300 μg/L or less is preferably brought into contact with the inner surface of the Cr-containing carbon steel pipe. When the oxygen concentration of water brought into contact with the inner surface of the Cr-containing carbon steel pipe is less than 10 μg/L, no oxide film is formed on the inner surface of the Cr-containing carbon steel pipe, and when the oxygen concentration exceeds 300 μg/L, pitting corrosion may occur in a formed oxide film. Thus, the oxygen concentration of the water brought into contact with the inner surface of the Cr-containing carbon steel pipe is set to a concentration in the range of 10 μg/L or more and 300 μg/L or less.

In order to perform the oxidizing treatment on the inner surface of the Cr-containing carbon steel pipe, the temperature of the oxygen-containing water to be supplied to the Cr-containing carbon steel pipe is preferably in a temperature range of 100° C. to 200° C. (100° C. or higher and 200° C. or lower). In order to perform the oxidizing treatment on the inner surface of the Cr-containing carbon steel pipe, a time for bringing the oxygen-containing water into contact with the inner surface of the Cr-containing carbon steel pipe is preferably a time in a range of 50 hours or longer and 500 hours or shorter.

Based on the experiment results shown in FIG. 2, the inventors has obtained a corrosion rate of the Cr 0.015 wt %-containing carbon steel pipe subjected to the oxidizing treatment (using data from 890 hours to 1720 hours), a corrosion rate of the Cr 0.31 wt %-containing carbon steel pipe before performing the oxidizing treatment (using data from 200 hours to 390 hours), and a corrosion rate of Cr 0.31 wt %-containing carbon steel pipe after the oxidizing treatment (using data from 1200 hours to 1720 hours). The obtained corrosion rates are shown in FIG. 4. According to FIG. 4, it has been found that the corrosion rate of the Cr 0.31 wt %-containing carbon steel pipe subjected to the oxidizing treatment is reduced to 1/10 that of the Cr 0.31 wt %-containing carbon steel pipe not subjected to the oxidizing treatment.

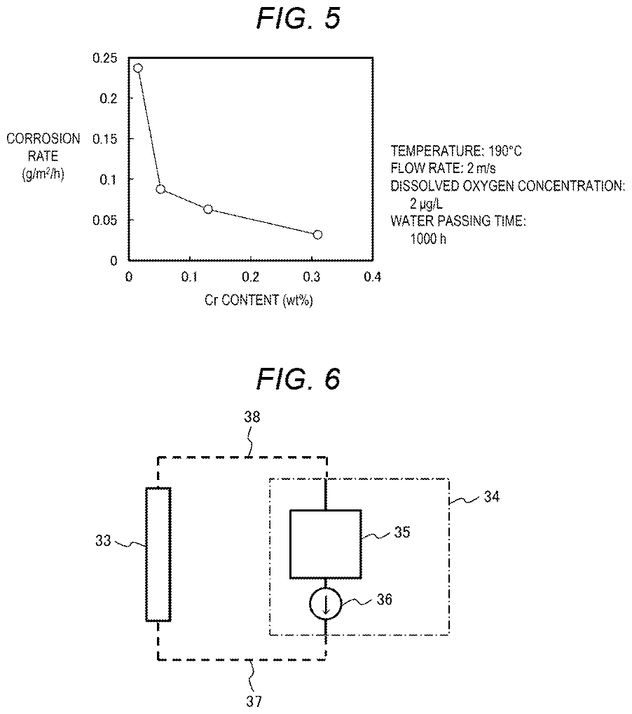

A relationship between the Cr content of the Cr-containing carbon steel pipe and the corrosion rate of the Cr-containing carbon steel pipe when the high-temperature water of 190° C. having the dissolved oxygen concentration of 2 μg/L passes through the Cr-containing carbon steel pipe at 2 m/s. According to the results shown in FIG. 5, when the Cr content of the Cr-containing carbon steel pipe is larger than 0.052 wt %, the corrosion rate of the Cr-containing carbon steel pipe is mitigated. Thus, it has been found that when the Cr content of the Cr-containing carbon steel pipe is larger than 0.052 wt %, the oxide film containing Cr may be formed on the inner surface of the Cr-containing carbon steel pipe.

Embodiments of the invention reflecting the above study results are described below.

### First Embodiment

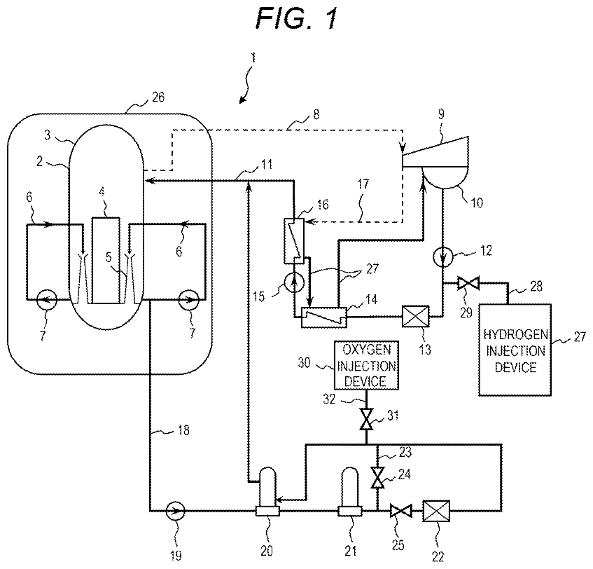

A corrosion mitigation method for carbon steel pipe according to a first embodiment applied to a boiling water reactor plant, which is a preferred embodiment of the invention, is described with reference to FIG. 1. The corrosion mitigation method for carbon steel pipe according to the present embodiment is applied to a clean up system pipe using a Cr-containing carbon steel pipe in the boiling water reactor plant (BWR plant).

A schematic configuration of a BWR plant 1 is described with reference to FIG. 1. The BWR plant 1 includes a reactor 2, a turbine 9, a condenser 10, a reactor water recirculation system, a reactor water clean up system, a water supply system, or the like. The reactor 2 includes a reactor pressure vessel (hereinafter referred to as RPV) 3 in which a reactor core 4 is incorporated, and a plurality of jet pumps 5 are disposed in an annular downcomer formed between an outer surface of a reactor core shroud (not shown) surrounding the reactor core 4 in the RPV 3 and an inner surface of the RPV 3. The reactor core 4 is loaded with a plurality of fuel assemblies (not shown). The fuel assembly includes a plurality of fuel rods (not shown) filled with a plurality of fuel pellets made of nuclear materials.

The reactor water recirculation system includes a reactor water recirculation system pipe made of stainless steel, and a recirculation pump 7 disposed in the reactor water recirculation system pipe 6. In the water supply system, a condensate pump 12, a condensate demineralizer (for example, a condensate clean up device) 13, a low pressure water supply heater 14, a water supply pump 15, and a high pressure water supply heater 16 are installed to a water supply pipe 11 in communication with the condenser 10 and the RPV 3, in this order from the condenser 10 to the RPV 3. A hydrogen injection device 27 is connected to the water supply pipe 11 between the condensate pump 12 and the condensate demineralizer 13 by a hydrogen injection pipe 28 provided with an on/off valve 29. In the reactor water clean up system, a clean up pump 19, a regenerative heat exchanger 20, a non-regenerative heat exchanger 21 and a reactor water clean up device 22 are installed to a clean up system pipe 18 in communication with the reactor water recirculation system pipe 6 and the water supply pipe 11 in this order. The clean up system pipe 18 is constituted by a Cr 0.31 wt %-containing carbon steel pipe.

An on/off valve 25 is installed in a portion of the clean up system pipe 18 between the non-regenerative heat exchanger 21 and the reactor water cleanup device 22. An end portion of a bypass pipe 23 that includes an on-off valve 24 is connected to a portion of the clean up system pipe 18 between the non-regenerative heat exchanger 21 and the on-off valve 25. The other end portion of the bypass pipe 23 is connected to a portion of the cleanup system pipe 18 downstream of the reactor water clean up device 22 and a portion of the clean up system pipe 18 between the reactor water clean up device 22 and the regenerative heat exchanger 20. The clean up system pipe 18 is connected to the reactor water recirculation system pipe 6 upstream of the recirculation pump 7. The reactor 2 is installed in a primary containment vessel 26 arranged in a reactor building (not shown).

An oxygen injection device 30 is connected, through an oxygen injection pipe 32 provided with an on-off valve 31, to the clean up system pipe 18 between a connection point of the bypass pipe 23 and the clean up system pipe 18 downstream of the reactor water clean up device 22 and the regenerative heat exchanger 20.

During a rated operation of the BWR plant 1, 280° C. cooling water (hereinafter referred to as reactor water) in the RPV 3 is pressurized by the recirculation pump 7, and ejected into the jet pump 5 through the reactor water recirculation system pipe 6. The reactor water present around a nozzle of the jet pump 5 in a downcomer is also sucked into the jet pump 5 and supplied to the reactor core 4. The reactor water supplied to the reactor core 4 is heated by heat generated by nuclear fission of the nuclear materials in the fuel rod, and a part of the heated reactor water becomes steam. The steam is guided from the RPV 3 through a main steam pipe 8 to the turbine 9 to rotate the turbine 9. An electric generator (not shown) connected to the turbine 9 rotates to generate electric power. The steam discharged from the turbine 9 is condensed into water by the condenser 10. The water is supplied to the RPV 3 as the supplied water through the water supply pipe 11. The supplied water flowing through the water supply pipe 11 is pressurized by the condensate pump 12, has impurities removed by the condensate demineralizer 13, and is further pressurized by the water supply pump 15. The supplied water is heated by the low pressure water supply heater 14 and the high pressure water supply heater 16 and guided into the RPV 3. Extraction steam extracted from the turbine 9 by an extraction pipe 17 is supplied to the low pressure water supply heater 14 and the high pressure water supply heater 16, respectively, as a heating source of the supplied water.

Apart of the reactor water flowing through the reactor water recirculation system pipe 6 flows into the clean up system pipe 18 due to driving of the clean up system pump 19, is cooled by the regenerative heat exchanger 20 and the non-regenerative heat exchanger 21, and is then purified by the reactor water clean up device 22. The purified reactor water is heated by the regenerative heat exchanger 20 and returned to the RPV 3 through the clean up system pipe 18 and the water supply pipe 11.

When the BWR plant 1 that has undergone operation is stopped for fuel exchange and maintenance and inspection, a reductive decontamination of the clean up system pipe 18 using an oxalic acid aqueous solution is performed, and an oxide film containing radioactive materials formed on the inner surface of the clean up system pipe 18 is removed.

After the fuel exchange and maintenance and inspection, in order to start an operation in a next operation cycle of the BWR plant 1 subjected to the above reductive decontamination, an upper lid is attached to the RPV 3 having an open upper end portion to seal the RPV 3, and the BWR plant 1 is activated. When the BWR plant 1 is activated, the reactor water in the RPV 3 is pressurized by the recirculation pump 7 and ejected into the jet pump 5 through the reactor water recirculation system pipe 6. The reactor water present around the nozzle of the jet pump 5 in the downcomer is also sucked into the jet pump 5 and supplied to the reactor core 4. The reactor water discharged from the reactor core is returned to the downcomer. A part of the reactor water flowing through the reactor water recirculation system pipe 6 is supplied from the reactor water recirculation system pipe 6 to the clean up system pipe 18, and as described above, is pressurized by the clean up system pump 19, and passes through the regenerative heat exchanger 20 and the non-regenerative heat exchanger 21 to be guided into the reactor water clean up device 22. The reactor water clean up device 22 removes radionuclides and impurities contained in the reactor water. The reactor water purified and discharged from the reactor water clean up device 22 recovers the heat in the regenerative heat exchanger 20 and rises in temperature, and is supplied to the RPV 3 through the clean up system pipe 18 and the water supply pipe 11. At this time, since a reactor output is 0%, a supply of the supplied water to the RPV 3 by the water supply pipe 11 is not performed.

The reactor water flowing through the reactor water recirculation system pipe 6 is heated by Joule heat generated due to the driving of the recirculation pump 7, and the temperature thereof rises to 100° C. due to the driving of the recirculation pump 7 for about half a day. Since the upper end portion of the RPV3 is open, high concentration dissolved oxygen is contained in the reactor water, and it is necessary to deaerate the dissolved oxygen of the reactor water. Since a space formed above the surface of the reactor water in the RPV 3 is in communication with the condenser 10 through a deaeration pipe (not shown), the pressure in the space in the RPV 3 is lowered due to driving of a vacuum pump (not shown) that makes the condenser 10 have a negative pressure, and the dissolved oxygen in the reactor water is deaerated. The deaerated oxygen is discharged from the RPV 3, guided to the condenser 10 through the deaeration pipe, and discharged to an off-gas system in communication with the vacuum pump.

After the above deaeration of the reactor water is completed, an on-off valve (not shown) provided in the deaeration pipe is closed, then, the on-off valve 31 is opened, and oxygen is injected into the clean up system pipe 18 downstream of the connection point between the bypass pipe 23 and the clean up system pipe 18 through the oxygen injection pipe 32 from the oxygen injection device 30. At this time, since the on-off valve 24 is open and the on-off valve 25 is closed, the reactor water discharged from the non-regenerative heat exchanger 21 flows through the bypass pipe 23. When arriving at the connection point between the oxygen injection pipe 32 and the clean up system pipe 18, oxygen from the oxygen injection device 30 is injected into the 100° C. reactor water. An opening degree of the on-off valve 31 is controlled to adjust an injection amount of oxygen such that the dissolved oxygen concentration in the reactor water flowing through the clean up system pipe 18 is 30 μg/L. The dissolved oxygen concentration in the reactor water flowing through the cleanup system pipe 18 being 30 μg/L can be confirmed by analyzing the reactor water sampled from the clean up system pipe 18. The 100° C. reactor water containing 30 μg/L dissolved oxygen circulates in a closed loop that includes a portion of the clean up system pipe 18 between a connection point of the reactor water recirculation system pipe 6 and the clean up system pipe 18 and the connection point of the clean up system pipe 18 and the bypass pipe 23, the bypass pipe 23, a portion of the cleanup system pipe 18 between the connection point of the bypass pipe 23 and the clean up system pipe 18 and a connection point of the clean up system pipe 18 and the water supply pipe 11, the water supply pipe 11 (a portion of the water supply pipe 11 closer to the RPV 3 than the connection point of the clean up system pipe 18 and the water supply pipe 11) and the RPV 3. The circulating reactor water having the dissolved oxygen concentration of 30 μg/L is brought into contact with the inner surface of the clean up system pipe 18, and due to the dissolved oxygen, the oxidizing treatment is performed on the inner surface of the clean up system pipe 18 constituted by the Cr 0.31 wt %-containing carbon steel pipe.

When the oxidizing treatment is performed on the inner surface of the clean up system pipe 18, the on-off valve 25 is closed, and the supply of the reactor water having the dissolved oxygen concentration of 30 μg/L to the reactor water cleanup device 22 is stopped. Since the reactor water containing oxygen is not supplied to the reactor water clean up device 22, it is possible to prevent an ion exchange resin present in the reactor water clean up device 22 from being deteriorated by the oxygen, and a lifetime reduction of the ion exchange resin adsorbing the radionuclide is mitigated.

Eventually, a control rod (not shown) is pulled out from the reactor core 4 to change the reactor core 4 from a subcritical state to a critical state, and the reactor water in the reactor core 4 is heated by the heat generated by the nuclear fission of the nuclear materials in the fuel rod. Steam is not generated in the reactor core 4, and steam is not yet supplied to the turbine 9. The temperature of the reactor water rises due to nuclear heating and becomes a temperature higher than 100° C. (a temperature of 200° C. or lower). The reactor water containing oxygen having a raised temperature is supplied to the clean up system pipe 18 and the oxidizing treatment of the inner surface of the clean up system pipe 18 is continuously performed. Due to the oxidizing treatment, for the inner surface of the clean up system pipe 18 constituted by the Cr 0.31 wt %-containing carbon steel pipe, an oxide film containing a Cr amount larger than the Cr amount (0.31 wt %) contained in this Cr-containing carbon steel pipe is formed on the inner surface of the clean up system pipe 18. Thus, the Cr amount contained in the formed oxide film increases because iron elutes from the Cr-containing carbon steel pipe into the reactor water, and the Cr remains.

The time for bringing the reactor water containing the dissolved oxygen concentration of 30 μg/L into contact with the inner surface of the clean up system pipe 18 is in a range of 50 hours or longer and 500 hours or shorter from a start of the oxygen injection from the oxygen injection device 30 to the clean up system pipe 18, for example, 300 hours. At a time when 300 hours have elapsed from the start of the oxygen injection, the temperature of the reactor water is in a range of 100° C. or higher and 200° C. or shorter.

Further, the control rod is pulled out from the reactor core 4, and in a temperature raising and pressurizing step of the reactor 2, the pressure in the RPV 3 is increased to a rated pressure, and the temperature of the reactor water in the RPV 3 is raised to a rated temperature (280° C.) by the heat generated by the nuclear fission. After the pressure in the RPV 3 becomes the rated pressure and the temperature of the reactor water rises to the rated temperature, by pulling out the control rod from the reactor core 4 and increasing a flow rate of the reactor water supplied to the reactor core 4, the reactor output is increased to a rated output (100% output). The rated operation of the BWR plant 1 that maintains the rated output is continued until an end of the operation cycle. When the reactor output increases to, for example, 10% output, the steam generated in the reactor core 4 is supplied to the turbine 9 through the main steam pipe 8 to start power generation, and thereafter and the power generation is continued by supplying the steam from the RPV 3 to the turbine 9 until the operation of the BWR plant 1 is completed. When the reactor output is 10% or more, water generated by condensation of the steam in the condenser is supplied to the RPV 3 through the water supply pipe 11.

When 300 hours have elapsed from the start of the oxygen injection into the clean up system pipe 18, the on-off valve 31 is closed and the on-off valve 29 is opened. Hydrogen is injected from the hydrogen injection device 27 into the water supply pipe 11. The hydrogen is supplied to the RPV 3 together with the supplied water. An opening degree of the on-off valve 29 is controlled to adjust the injection amount of the hydrogen into the water supply pipe 11 such that the dissolved oxygen concentration in the reactor water is 2 μg/L. The dissolved oxygen concentration in the reactor water flowing through the clean up system pipe 18 being 2 μg/L can be confirmed by analyzing the reactor water sampled from the cleanup system pipe 18. After the dissolved oxygen concentration in the reactor water is lowered to 2 μg/L, the on-off valve 25 is opened and the on-off valve 24 is closed, and the reactor water is supplied to the reactor water clean up device 22. The hydrogen injection from the hydrogen injection device 27 is performed until the operation of the BWR plant 1 in this operation cycle is completed.

According to the present embodiment, the Cr-containing oxide film formed on the inner surface of the clean up system pipe 18 by being brought into contact with the reactor water having a high dissolved oxygen concentration (for example, 30 μg/L) is maintained in a state of being formed on the inner surface, even when thereafter the reactor water having a low dissolved oxygen concentration (for example, 2 μg/L) is brought into contact with the inner surface of the clean up system pipe 18. Thus, the corrosion of the clean up system pipe 18 is mitigated remarkably.

A small amount of radionuclide contained in the reactor water in the RPV 3 adheres to the inner surface of the Cr-containing carbon steel pipe constituting the clean up system pipe 18. However, by performing the oxidizing treatment in the present embodiment on the inner surface thereof to mitigate the corrosion of the Cr-containing carbon steel pipe, the amount of the radionuclide adhering to the inner surface of the clean up system pipe 18 due to the corrosion can be remarkably reduced. Thus, in the present embodiment, a radiation exposure of an operator during the maintenance and inspection of the BWR plant 1 can be remarkably mitigated.

In the present embodiment, since the clean up system pipe 18 is constituted by the Cr-containing carbon steel pipe, during the operation of the BWR plant, even when a noble metal (for example, platinum) is injected into the reactor water in the RPV 3 through, for example, the water supply pipe, the corrosion of the clean up system pipe 18 can be mitigated. That is, the corrosion of the clean up system pipe 18 constituted by the Cr-containing carbon steel pipe due to the platinum injection can be mitigated more than the corrosion generated by the clean up system pipe constituted by a carbon steel pipe not containing Cr. According to the present embodiment, since the oxidizing treatment is performed on the inner surface of the clean up system pipe 18 constituted by the Cr 0.31 wt %-containing carbon steel pipe, which is a Cr-containing carbon steel pipe containing Cr in a range larger than 0.052 wt % and less than 0.4 wt %, to form an oxide film containing 0.31 wt % Cr, the corrosion in the clean up system pipe 18 caused by the platinum contained in the reactor water flowing through the clean up system pipe 18 is further mitigated. Such an effect is also obtained in second and third embodiments described later.

The present embodiment can also be applied to the clean up system pipe 18 constituted by, for example, the Cr 0.31 wt %-containing carbon steel pipe of a newly installed BWR plant 1.

### Second Embodiment

A corrosion mitigation method for carbon steel pipe according to the second embodiment applied to the boiling water reactor plant, which is another preferred embodiment of the invention, is described with reference to FIG. 6. In the corrosion mitigation method for carbon steel pipe of the present embodiment, a heated water circulation device 34 shown in FIG. 6 is used.

The heated water circulation device 34 includes a heating device 35, a circulation pump 36, a pipe (water supply pipe) 37, and a pipe 38. The pipe 37 is connected to an outlet side of the heating device 35, and the circulation pump 36 is installed in the pipe 37. The pipe 38 is connected to an inlet side of the heating device 35. A water introduction pipe (not shown) is connected to the pipe 37 and a drain pipe (not shown) is connected to the pipe 38.

In the corrosion mitigation method for carbon steel pipe of the present embodiment, the heated water circulation device 34 is used to perform the oxidizing treatment on the inner surface of the Cr-containing carbon steel pipe. The Cr-containing carbon steel pipe subjected to the oxidizing treatment on the inner surface, for example, a Cr 0.31 wt %-containing carbon steel pipe 33 is connected to each of the pipes 37 and 38 of the heated water circulation device 34. That is, the pipe 37 is connected to an end portion of the Cr 0.31 wt %-containing carbon steel pipe 33, and the pipe 38 is connected to the other end portion of the Cr 0.31 wt %-containing carbon steel pipe 33. A closed loop that includes the Cr 0.31 wt %-containing carbon steel pipe 33, the pipe 38, the heating device 35 and the pipe 37 is formed. The oxygen-containing water is supplied from the water introduction pipe to the pipe 37 such that water is filled in the 0.33 wt % Cr-containing carbon steel pipe 33, the pipe 38, the heating device 35 and the pipe 37.

The water in the closed loop is pressurized by the circulation pump 36 and circulated in the closed loop, and the circulating water is heated by the heating device 35. By this heating, the circulating water is heated to a range of 100° C. to 200° C., for example, 150° C. Although not shown in FIG. 6, the oxygen injection device 30 shown in FIG. 1 is connected to the pipe 37 through the oxygen injection pipe 32 that includes the on-off valve 31. The oxygen injection device 30 may be connected to the pipe 38 through the oxygen injection pipe 32 instead of the pipe 37. The opening degree of the on-off valve 31 is controlled to adjust an amount of the oxygen supplied from the oxygen injection device 30 to the pipe 37 through the oxygen injection pipe 32 such that the dissolved oxygen concentration of the water supplied to the Cr 0.31 wt %-containing carbon steel pipe 33 is 30 μg/L. When water of 150° C. having the dissolved oxygen concentration of 30 μg/L is brought into contact with the inner surface of the Cr 0.31 wt %-containing carbon steel pipe 33, the inner surface is subjected to the oxidizing treatment to form the oxide film containing 0.31 wt % Cr. The oxygen-containing water of 150° C. is brought into contact with the inner surface of the Cr 0.31 wt %-containing carbon steel pipe 33 in a range of 50 hours to 500 hours, for example, 300 hours.

When 300 hours have elapsed, driving of the circulation pump 36 and the heating of the heating device 35 are stopped, and the water in the closed loop is discharged from the drain pipe. After the temperature of the Cr 0.31 wt %-containing carbon steel pipe 33 is lowered by cooling, the Cr 0.31 wt %-containing carbon steel pipe 33 having the inner surface subjected to the oxidizing treatment is removed from the pipes 37 and 38. Then, a new Cr 0.31 wt %-containing carbon steel pipe 33 is connected to each of the pipes 37 and 38, and using the heated water circulation device 34, the oxidizing treatment is performed on the inner surface of the new Cr 0.31 wt %-containing carbon steel pipe 33.

The clean up system pipe 18 of the new BWR plant 1 is constituted by welding and connecting a plurality of Cr 0.31 wt %-containing carbon steel pipes 33 having the inner surface subjected to the oxidizing treatment. After a construction of the new BWR plant 1 constituted by the clean up system pipe 18 is completed, the operation of the BWR plant 1 is started. Similar to the first embodiment, the BWR plant 1 also enters a rated operation state after a heating and pressurizing step and a reactor output increasing step in the present embodiment. In the BWR plant 1 in which such an operation is performed, the reactor output becomes 10% and the supplied water is supplied to the RPV 3 through the water supply pipe 11. At this time, the on-off valve 29 is opened, and the hydrogen is injected from the hydrogen injection device 27 into the water supply pipe 11. The hydrogen is supplied to the RPV 3 together with the supplied water. The opening degree of the on-off valve 29 is controlled to adjust the injection amount of the hydrogen into the water supply pipe 11 such that the dissolved oxygen concentration in the reactor water is 2 μg/L. The hydrogen injection from the hydrogen injection device 27 is performed until the operation of the BWR plant 1 in the operation cycle is completed.

In the present embodiment, the effect produced in the first embodiment can be obtained.

The Cr 0.31 wt %-containing carbon steel pipe 33 having the inner surface subjected to the oxidizing treatment using the heated water circulation device 34 is not only used for a configuration of the clean up system pipe 18 of the new BWR plant 1 as described above, but also can be applied to the clean up system pipe 18 of an existing BWR plant 1 that has experienced the operation. That is, during the maintenance and inspection after stopping the operation of the existing BWR plant 1, when damage is found in a portion of the clean up system pipe 18, the damaged portion of the clean up system pipe 18 is cut and removed and repaired using a new Cr-containing carbon steel pipe. This new Cr-containing carbon steel pipe is the Cr 0.31 wt %-containing carbon steel pipe 33 having the inner surface subjected to the oxidizing treatment using the heated water circulation device 34. The Cr 0.31 wt %-containing carbon steel pipe 33 having the inner surface subjected to the oxidizing treatment is transported to a location of a target BWR plant 1 and disposed at a position where the damaged portion of the clean up system pipe 18 has been removed. An end of the Cr 0.31 wt %-containing carbon steel pipe 33 having the inner surface subjected to the oxidizing treatment is connected to a cut end portion of the clean up system pipe 18 by welding, and the other end of the Cr 0.31 wt %-containing carbon steel pipe 33 is connected to the other cut end portion of the clean up system pipe 18 by welding. As a result, the clean up system pipe 18 from which the damaged portion has been removed is repaired by the Cr 0.31 wt %-containing carbon steel pipe 33 having the inner surface subjected to the oxidizing treatment.

After the clean up system pipe 18 is repaired and a maintenance and inspection work is completed, the existing BWR plant 1 that has been stopped is started. After this starting, the hydrogen is injected from the hydrogen injection device 27 into the water supply pipe 11, and the injected hydrogen is supplied to the RPV 3. By injecting the hydrogen, the dissolved oxygen concentration in the reactor water becomes 2 μg/L. The hydrogen injection from the hydrogen injection device 27 is performed until the operation of the existing BWR plant 1 in this operation cycle is completed.

### Third Embodiment

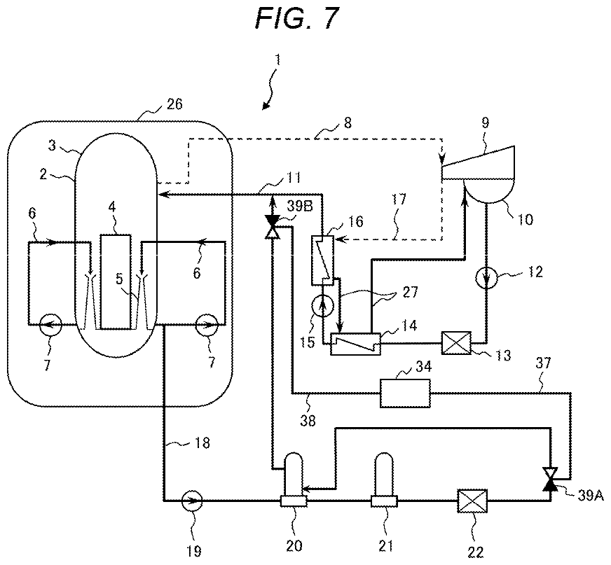

A corrosion mitigation method for carbon steel pipe according to the third embodiment, which is another preferred embodiment of the invention, is described with reference to FIG. 7. The corrosion mitigation method for carbon steel pipe according to the present embodiment is applied to the clean up system pipe using the Cr-containing carbon steel pipe in the BWR plant. The corrosion mitigation method for carbon steel pipe according to the first embodiment is implemented in the clean up system pipe 18 of the BWR plant 1 after the starting, while the corrosion mitigation method for carbon steel pipe according to the present embodiment is implemented in the clean up system pipe 18 when the operation of the BWR plant 1 is stopped.

In the corrosion mitigation method for carbon steel pipe according to the present embodiment, the heated water circulation device 34 used in the second embodiment is used. When the operation of the BWR plant 1 is stopped, the heated water circulation device 34 is connected to the clean up system pipe 18. The clean up system pipe 18 is constituted by, for example, the Cr 0.31 wt %-containing carbon steel pipe. When the operation of the BWR plant 1 is stopped, a bonnet of a valve 39A provided between the reactor water clean up device 22 and the regenerative heat exchanger 20 in the clean up system pipe 18 downstream of the reactor water clean up device 22 is opened to block a reactor water clean up device 22 side. An end portion of the pipe 37 of the heated water circulation device 34 is connected to a flange of the valve 39A, and the end portion of the pipe 37 is connected to the clean up system pipe 18 downstream of the reactor water clean up device 22. A bonnet of a valve 39B provided between the connection point of the cleanup system pipe 18 and the water supply pipe 11 downstream of the reactor water clean up device 22 and the regenerative heat exchanger 20 is opened to block a water supply pipe 11 side. An end portion of the pipe 38 of the heated water circulation device 34 is connected to a flange of the valve 39B, and the end portion of the pipe 38 is connected to the clean up system pipe 18 in the vicinity of the water supply pipe 11. Each of the end portion of the pipe 37 and the end portion of the pipe 38 is connected to the clean up system pipe 18, and a closed loop that includes the clean up system pipe 18 and the pipes 37 and 38 is formed.

A portion of the clean up system pipe 18 between the valve 39A and the valve 39B is constituted by the Cr 0.31 wt %-containing carbon steel pipe. The oxygen-containing water is supplied from the water introduction pipe to the pipe 37 such that the water is filled in the portion of the clean up system pipe 18 between the valve 39A and the valve 39B, and in the pipes 37 and 38.

The water in the closed loop is pressurized by the circulation pump 36 and circulated in the closed loop, and the circulating water is heated by the heating device 35. By this heating, the circulating water is heated to a range of 100° C. to 200° C., for example, 150° C. The opening degree of the on-off valve 31 is controlled to adjust the amount of the oxygen supplied from the oxygen injection device 30 to the pipe 37 through the oxygen injection pipe 32 in the same manner as in the second embodiment, and the dissolved oxygen concentration of the water flowing through the clean up system pipe 18 between the valve 39A and the valve 39B is adjusted to be 30 μg/L. When the water of 150° C. having the dissolved oxygen concentration of 30 μg/L is brought into contact with the inner surface of the clean up system pipe 18 between the valve 39A and the valve 39B, the inner surface is subjected to the oxidizing treatment to form the oxide film containing 0.31 wt % Cr. The oxygen-containing water of 150° C. is brought into contact with the inner surface of the Cr 0.31 wt %-containing carbon steel pipe 33 in a range of 50 hours to 500 hours, for example, 300 hours.

When 300 hours have elapsed, the driving of the circulation pump 36 and the heating of the heating device 35 are stopped, and the water in the closed loop is discharged from the drain pipe connected to the pipe 38. The water in the closed loop discharged through the drain pipe (this water is a radioactive waste liquid because of being in contact with the inner surface of the clean up system pipe 18) is discharged to a waste liquid treatment device (not shown) through a high-pressure hose and treated by the waste liquid treatment device.

After the oxide film containing Cr is formed on the inner surface of the clean up system pipe 18, the pipe 37 is removed from the valve 39A, the pipe 38 is removed from the valve 39B, and each of the valves 39A and 39B is restored.

Thereafter, the operation of the BWR plant 1 is started. Similar to the first embodiment, the BWR plant 1 also enters the rated operation state after the heating and pressurizing step and the reactor output increasing step in the present embodiment. In the BWR plant 1 in which such an operation is performed, when the reactor output becomes 10%, the on-off valve 29 is opened and the hydrogen is injected from the hydrogen injection device 27 into the water supply pipe 11. The injected hydrogen is supplied to the RPV 3 and injected into the reactor water in the RPV 3. By injecting the hydrogen into the reactor water, the oxygen contained in the reactor water and the hydrogen react with each other by an action of the noble metal injected into the reactor water to produce water. The dissolved oxygen concentration in the reactor water is lowered, and the dissolved oxygen concentration in the reactor water becomes 2 μg/L. The hydrogen injection from the hydrogen injection device 27 is performed until the operation of the BWR plant 1 in the operation cycle is completed.

In the present embodiment, the effect produced in the first embodiment can be obtained. In the present embodiment, since the heated water circulation device 34 is used, the oxidizing treatment on the inner surface of the cleanup system pipe 18 can be performed when the operation of the BWR plant 1 is stopped.

When the damaged portion of the clean up system pipe 18 of the BWR plant 1 is repaired using a new Cr 0.31 wt %-containing carbon steel pipe, the present embodiment can also be applied even in the case of performing the oxidizing treatment on the inner surface of the portion of the clean up system pipe 18 repaired by, for example, using the Cr 0.31 wt %-containing carbon steel pipe.

The damaged portion of the clean up system pipe 18 is cut and removed from the clean up system pipe 18, and the new Cr 0.31 wt %-containing carbon steel pipe is used to repair the clean up system pipe 18. Each of the pipes 37 and 38 of the heated water circulation device 34 is connected to the clean up system pipe 18 through the valves 39A and 39B as described above such that the Cr 0.31 wt %-containing carbon steel pipe of the repaired clean up system pipe 18 is included in the closed loop that includes the pipes 37 and 38.

The water in the closed loop is pressurized by the circulation pump 36 while being heated by the heating device 35 and circulates in the closed loop. By bringing the water having the dissolved oxygen concentration of 30 μg/L heated to 150° C. into contact with the inner surface of the clean up system pipe 18 including the Cr 0.31 wt %-containing carbon steel pipe between the valve 39A and the valve 39B, the inner surface is subjected to the oxidizing treatment to form the above oxide film.

Then, each of the pipes 37 and 38 is removed from the clean up system pipe 18 to restore each of the valves 39A and 39B, and the BWR plant 1 is started. After the start of the BWR plant 1, hydrogen is injected into the reactor water in the RPV 3, and the reactor water containing the hydrogen is guided to the clean up system pipe 18 repaired by using the Cr 0.31 wt %-containing carbon steel pipe.

### Fourth Embodiment

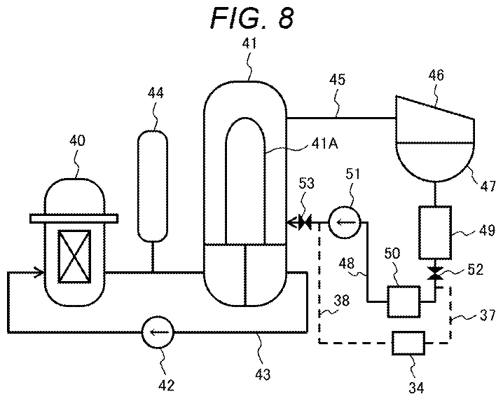

A corrosion mitigation method for carbon steel pipe according to a fourth embodiment, which is another preferred embodiment of the invention, is described with reference to FIG. 8. The corrosion mitigation method for carbon steel pipe according to the present embodiment is applied to the water supply pipe using the Cr-containing carbon steel pipe of a pressurized water reactor plant (hereinafter referred to as a PWR plant). The corrosion mitigation method for carbon steel pipe according to the present embodiment is implemented in the water supply pipe when the PWR plant is stopped.

A schematic configuration of the PWR plant is described with reference to FIG. 8. The PWR plant includes a reactor pressure vessel 40, a steam generator 41, a pressurizer 44, a turbine 46 and a condenser 47. A reactor core of the reactor pressure vessel 40 is loaded with a plurality of fuel assemblies (not shown) that include nuclear materials. The PWR plant includes a primary cooling system and a secondary cooling system. The primary cooling system is constituted by connecting the reactor pressure vessel 40, the steam generator 41 and a circulation pump 42 through a pipe 43. The pressurizer 44 is connected to a portion of the pipe 43 between the reactor pressure vessel 40 and the steam generator 41. A plurality of heat transfer tubes 41A are installed in the steam generator 41. The pipe 43 is in communication with a heat transfer tube side of the steam generator 41. The secondary cooling system is constituted by communicating a shell side of the steam generator 41 with the turbine 46 through a main steam pipe 45 and communicating the condenser 47 with the shell side of the steam generator 41 through a water supply pipe 48. The water supply pipe 18 is constituted by the Cr 0.31 wt %-containing carbon steel pipe. A demineralizer 49, a deaerator 50 and a water supply pump 51 are provided in the water supply pipe 48. An on-off valve 52 is provided in the water supply pipe 48 between the condenser 47 and the demineralizer 49, and an on-off valve 53 is provided in the water supply pipe 48 between the water supply pump 51 and the steam generator 41.

During the operation of the PWR plant, the reactor water pressurized by the circulation pump 42 is supplied to the reactor pressure vessel 40 through the pipe 43. The reactor water that has reached the reactor pressure vessel 40 is heated by the heat generated by the nuclear fission of the nuclear materials in the fuel assembly in the reactor core, and the temperature rises. The heated reactor water is supplied into each heat transfer tube 41A of the steam generator 41 through the pipe 43. The reactor water discharged from these heat transfer tubes 41A is pressurized by the circulation pump 42 and guided to the reactor pressure vessel 40.

The supplied water pressurized by the water supply pump 51 is supplied to the shell side of the steam generator 41 (a region outside the heat transfer pipe 41A in the steam generator 41) through the water supply pipe 48. The supplied water is heated by the reactor water supplied to each heat transfer tube 41A of the steam generator 41 to generate steam. The generated steam is discharged from the shell side of the steam generator 41 to the main steam pipe 45. The steam is supplied to the turbine 46 through the main steam pipe 45 to rotate the turbine 46. An electric generator (not shown) connected to the turbine 46 also rotates to generate the electric power. The steam discharged from the turbine 46 is condensed to water by the condenser 47. This water is guided through the water supply pipe 48 as the supplied water, is pressurized by the water supply pump 51, and is supplied to the shell side of the steam generator 41. The supplied water flowing through the water supply pipe 48 is purified by the demineralizer 49. In particular, in the condenser 47, the steam discharged from the turbine 46 is condensed by seawater supplied to a heat transfer tube (not shown) installed in the condenser 47. However, when this heat transfer tube is damaged and the seawater leaks from the heat transfer tube to the supplied water in the condenser 47, seawater components (sodium ions and chloride ions) contained in the supplied water are removed by the demineralizer 49, and the seawater components are prevented from flowing into the steam generator 41.

Further, the deaerator 50 provided in the water supply pipe 48 removes dissolved oxygen gas contained in the supplied water. Thus, the dissolved oxygen concentration of the supplied water discharged from the deaerator 50 is lowered, and the supplied water with the lower dissolved oxygen concentration is supplied to the steam generator 41. Thus, soundness of the steam generator 41 can be improved.

Instead of lowering the dissolved oxygen concentration of the supplied water using the deaerator 50, chemicals such as hydrazine may be added to the supplied water flowing through the water supply pipe 48 to chemically remove the dissolved oxygen contained in the supplied water. In order to mitigate the carbon steel pipe constituting the water supply pipe 48 from corroding by lowering the dissolved oxygen concentration of the supplied water flowing through the water supply pipe 48, the chemicals such as ammonia are added to make the pH of the water supply alkaline.

In the corrosion mitigation method for carbon steel pipe according to the present embodiment, the end portion of the pipe 37 of the heated water circulation device 34 is connected to the water supply pipe 48 in the vicinity of the on-off valve 52, and the end portion of the pipe 38 of the heated water circulation device 34 is connected to the water supply pipe 48 in the vicinity of the on-off valve 53. As a result, a closed loop that includes the water supply pipe 48 and the pipes 37 and 38 is formed.

The oxygen-containing water is supplied from the water introduction pipe to the pipe 37 such that the water is filled in a portion of the water supply pipe 48 between the on-off valve 52 and the on-off valve 53, and the pipes 37 and 38. The water in the closed loop is pressurized by the circulation pump 36 and circulated in the closed loop, and the circulating water is heated by the heating device 35 of the heated water circulation device 34. By this heating, the circulating water is heated to the range of 100° C. to 200° C., for example, 150° C. Although not shown in FIG. 8, the oxygen injection device 30 shown in FIG. 1 is connected to the pipe 37 through the oxygen injection pipe 32 that includes the on-off valve 31. The oxygen injection device 30 may be connected to the pipe 38 through the oxygen injection pipe 32 instead of the pipe 37. The opening degree of the on-off valve 31 is controlled to adjust the amount of the oxygen supplied from the oxygen injection device 30 to the pipe 37 through the oxygen injection pipe 32 in the same manner as in the second embodiment, and the dissolved oxygen concentration of the water flowing through the water supply pipe 48 between a connection point of the pipe 37 and the water supply pipe 48 and a connection point of the pipe 38 and the water supply pipe 48 is adjusted to be 30 μg/L. When the water of 150° C. having the dissolved oxygen concentration of 30 μg/L is brought into contact with the inner surface of the Cr 0.31 wt %-containing carbon steel pipe constituting the water supply pipe 48, that is, the water supply pipe 48 between the on-off valve 52 and the on-off valve 53, the inner surface is subjected the oxidizing treatment to form the oxide film containing 0.31 wt % Cr. The oxygen-containing water of 150° C. is brought into contact with the inner surface of the Cr 0.31 wt %-containing carbon steel pipe 33 in a range of 50 hours to 500 hours, for example, 300 hours. In the water supply pipe 48 between the connection point of the pipe 37 and the water supply pipe 48 and the connection point of the pipe 38 and the water supply pipe 48, while flowing the water having the dissolved oxygen concentration of 30 μg/L and performing the oxidizing treatment on the inner surface of a section of the water supply pipe 48, a deaeration function of the deaerator 50 is stopped.

When 300 hours have elapsed, the driving of the circulation pump 36 and the heating due to the heating device 35 are stopped, and the water in the closed loop, as the radioactive waste liquid, is discharged from the drain pipe connected to the pipe 38. The radioactive waste liquid discharged through the drain pipe is discharged to the waste liquid treatment device (not shown) through the high-pressure hose and treated by the waste liquid treatment device.

After the oxide film is formed on the inner surface of the water supply pipe 48 by the oxidizing treatment, the pipe 37 is removed from the valve 39A, the pipe 38 is removed from the valve 39B, and each of the valves 39A and 39B is restored.

Thereafter, the operation of the PWR plant is started. In the PWR plant, when the water supply from the condenser 47 to the steam generator 41 is started, the dissolved oxygen contained in the supplied water is deaerated by the deaerator 50 and the dissolved oxygen concentration of the supplied water is lowered to 2 μg/L. The deaeration of the supplied water by the deaerator 50 is performed until the operation of the PWR plant in the operation cycle is completed.

According to the present embodiment, in the PWR plant, the Cr-containing oxide film formed on the inner surface of the water supply pipe 48 by being brought into contact with the supplied water having the high-concentration dissolved oxygen concentration (for example, 30 μg/L) is maintained in a state of being formed on the inner surface thereof, and even when thereafter the supplied water having the low-concentration dissolved oxygen concentration (for example, 2 μg/L) is brought into contact with the inner surface of the water supply pipe 48. Thus, the corrosion of the water supply pipe 48 is mitigated remarkably.

The present embodiment can be applied to the water supply pipe 11 of the BWR plant 1 shown in FIG. 1. That is, the end portion of the pipe 37 of the heated water circulation device 34 is connected to the water supply pipe 11 upstream of the low pressure water supply heater 14 provided in the water supply pipe 11 constituted by the Cr 0.31 wt %-containing carbon steel pipe of the BWR plant 1, and the end portion of the pipe 38 is connected to the water supply pipe 11 downstream of the high-pressure water supply heater 16 provided in the water supply pipe 11. The water heated by the heating device 35 of the heated water circulation device 34, for example, having the temperature of 150° C. and having the dissolved oxygen concentration of 30 μg/L is brought into contact with the inner surface of the water supply pipe 11 and is subjected to the oxidizing treatment. After the oxide film containing Cr is formed on the inner surface of the water supply pipe 11, the pipes 37 and 38 are removed from the water supply pipe. Then, the hydrogen injected from the hydrogen injection device 27 connected to the water supply pipe 11 is supplied to the RPV 3. Thus, the dissolved oxygen concentration of the water supply that passes the water supply pipe 11 is lowered to 2 μg/L.

What is claimed is:

1. A corrosion mitigation method for carbon steel pipe, the corrosion mitigation method comprising:
supplying oxygen-containing water to a Cr-containing carbon steel pipe which contains Cr in a range of larger than 0.052 wt % and less than 0.4 wt %, and constitutes a carbon steel pipe of a reactor plant; and
performing an oxidizing treatment on an inner surface of the Cr-containing carbon steel pipe with the oxygen-containing water.

2. The corrosion mitigation method for carbon steel pipe according to claim 1, wherein
the Cr-containing carbon steel pipe containing Cr in the range of larger than 0.052 wt % and less than 0.4 wt % is a Cr-containing carbon steel pipe containing Cr in the range of larger than 0.052 wt % and less than 0.4 wt %, C in a range of 0.30 wt % or more and 0.33 wt % or less, Si in a range of 0.10 wt % or more and 0.35 wt % or less, Mn in a range of 0.30 wt % or more and 1.00 wt % or less, P in an amount of 0.035 wt % or less, S in an amount of 0.035 wt % or less, and Fe as a remainder.

3. The corrosion mitigation method for carbon steel pipe according to claim 2, wherein
Cr in the range of larger than 0.052 wt % and less than 0.4 wt % is Cr in a range of 0.06 wt % or more and 0.39 wt % or less.

4. The corrosion mitigation method for carbon steel pipe according to claim 1, wherein
as the Cr-containing carbon steel pipe, a Cr-containing carbon steel pipe containing Cr in a range of 0.13 wt % or more and less than 0.4 wt % is used.

5. The corrosion mitigation method for carbon steel pipe according to claim 4, wherein
the Cr-containing carbon steel pipe containing Cr in the range of 0.13 wt % or more and less than 0.4 wt % is a Cr-containing carbon steel pipe containing Cr in the range of 0.13 wt % or more and less than 0.4 wt %, C in a range of 0.30 wt % or more and 0.33 wt % or less, Si in a range of 0.10 wt % or more and 0.35 wt % or less, Mn in a range of 0.30 wt % or more and 1.00 wt % or less, P in an amount of 0.035 wt % or less, S in an amount of 0.035 wt % or less, and Fe as a remainder.

6. The corrosion mitigation method for carbon steel pipe according to claim 5, wherein
Cr in the range of 0.13 wt % or more and less than 0.4 wt % is Cr in a range of 0.13 wt % or more and 0.39 wt % or less.

7. The corrosion mitigation method for carbon steel pipe according to claim 1, wherein
reactor water in a reactor pressure vessel is supplied as the oxygen-containing water to the Cr-containing carbon steel pipe in communication with the reactor pressure vessel of the reactor plant during an operation of the reactor plant, and
the oxidizing treatment on the inner surface of the Cr-containing carbon steel pipe is performed by bring the reactor water containing oxygen into contact with the inner surface of the Cr-containing carbon steel pipe during the operation.

8. The corrosion mitigation method for carbon steel pipe according to claim 1, wherein
the oxygen-containing water is supplied to the Cr-containing carbon steel pipe in communication with the reactor pressure vessel of the reactor plant, after a stop of the operation of the reactor plant and before a start of the reactor plant, through a water supply pipe connected to the Cr-containing carbon steel pipe, and
the oxidizing treatment on the inner surface of the Cr-containing carbon steel pipe is performed by bring, after the stop of the operation of the reactor plant and before the start of the reactor plant, the oxygen-containing water supplied by the water supply pipe into contact with the inner surface of the Cr-containing carbon steel pipe.

9. The corrosion mitigation method for carbon steel pipe according to claim 8, wherein
the oxygen-containing water circulates in a closed loop which includes the Cr-containing carbon steel pipe and the water supply pipe after the stop of the operation of the reactor plant and before the start of the reactor plant.

10. The corrosion mitigation method for carbon steel pipe according to claim 1, wherein
the oxygen-containing water is supplied to the Cr-containing carbon steel pipe in communication with a steam generator to which reactor water heated in a reactor pressure vessel of the reactor plant is supplied, after the stop of the operation of the reactor plant and before the start of the reactor plant, through a water supply pipe connected to the Cr-containing carbon steel pipe, and
the oxidizing treatment on the inner surface of the Cr-containing carbon steel pipe is performed by bringing, after a stop of the operation of the reactor plant and before a start of the reactor plant, the oxygen-containing water supplied by the water supply pipe into contact with the inner surface of the Cr-containing carbon steel pipe.

11. The corrosion mitigation method for carbon steel pipe according to claim 1, wherein
the oxidizing treatment on the inner surface of the Cr-containing carbon steel pipe with the oxygen-containing water is performed, before the Cr-containing carbon steel pipe is in communication with either a reactor pressure vessel of the reactor plant or a steam generator supplied with reactor water heated in the reactor pressure vessel of the reactor plant, on the Cr-containing carbon steel pipe in a state where the oxidizing treatment is not performed, and
the Cr-containing carbon steel pipe subjected to the oxidizing treatment on the inner surface is incorporated into the rector plant and is in communication with either the reactor pressure vessel or the steam generator.

12. The corrosion mitigation method for carbon steel pipe according to claim 1, wherein
the oxidizing treatment on the inner surface of the Cr-containing carbon steel pipe is performed by using the oxygen-containing water in which an oxygen concentration is in a range of 10 μg/L or more and 300 μg/L or less and a temperature is in a range of 100° C. or higher and 200° C. or lower.

13. The corrosion mitigation method for carbon steel pipe according to claim 12, wherein
the oxidizing treatment is performed by bringing the oxygen-containing water into contact with the inner surface of the Cr-containing carbon steel pipe for a time in a range of 50 hours or more and 500 hours or less.
